(19) United States
(12) Patent Application Publication
(10) Pub. No.: US 2005/0073791 A1
(43) Pub. Date: Apr. 7, 2005

(54) Surge protection of capacitor used for AC power filtering

(76) Inventor: Martin H. Graham, Berkeley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/677,392

(22) Filed: Oct. 1, 2003

(51) Int. Cl. H02H 1/00

(52) U.S. Cl. 361/117

(57) ABSTRACT

A circuit for providing surge protection for a capacitor which is used to attenuate high-frequency components in an AC power signal is disclosed. A varistor is coupled between the gate and anode of a TRIAC in one embodiment.

### FIELD OF THE INVENTION

The invention relates to the field of surge protection of capacitors, specifically where the capacitors are coupled across an alternating current power source.

### PRIOR ART

Often in homes and businesses, the alternating current (AC) power signal contains numerous high-frequency components not generated with, for instance, the 60 Hz alternating current (AC) power signal. These high-frequency components are caused, for example, by switched power supplies, dimmers, motors, and other sources and are at frequencies substantially higher than the fundamental frequency of the AC power signal. There are numerous reasons why these high-frequency components are undesirable and should preferably be removed from the power signal.

One way of attenuating the high-frequency components is to connect a capacitor across the power source to shunt or attenuate the high-frequency components. For example, an ordinary plug may be used to connect the capacitors to a power source at a standard 120 volt AC receptacle.

Typically, the capacitors are rated to withstand a predetermined maximum voltage. If the alternating current power signal at the source experiences an unusually high voltage (a surge) as sometimes occurs, the capacitors can exceed their rated voltage and be damaged. The present invention describes a surge protection circuit for the capacitors.

The present invention may be used in conjunction with a capacitor discharge circuit such as described in U.S. Pat. No. 6,424,125. FIG. 1 of this patent, which will be discussed later, is FIG. 1 of U.S. Pat. No. 6,424,125.

Varistors are often used for surge protection. Some varistors, once they begin conducting, have a constant voltage drop equal to the voltage at which they begin conducting. For a 120 volt AC circuit, a varistor typically conducts at 330 volts. This relatively high voltage drop across the varistor and its corresponding low resistance may result in high power dissipation in the varistor. In many instances a circuit breaker is used with the varistor to protect it from excess current. In these cases, a light is often used to indicate the breaker's state.

Another category of varistors has the characteristic of exhibiting a low voltage drop once triggered. This characteristic is referred to as a “cross-bar” response or characteristic. Once triggered the varistor places, essentially, a short across the power source. Lower power is dissipated in these varistors, nonetheless, a circuit breaker (and indicator light) are often used to protect against high currents.

### SUMMARY OF THE INVENTION

A surge protection circuit for use with a capacitor, specifically a capacitor coupled to remove high-frequency components from an alternating current power signal is disclosed. A control device having two terminals and a control electrode is coupled to the capacitor. A variable resistor such as a varistor is coupled between one of the terminals and the gate of the control device. The variable resistor causes the control device to conduct in the presence of the unusually high voltage. In one embodiment the control device is a TRIAC.

### BRIEF DESCRIPTION OF THE DRAWINGS

FIG. 1 is a schematic of a prior art capacitor discharging circuit taken from U.S. Pat. No. 6,424,125.

FIG. 2 is an electrical schematic showing a discharge circuit such as the one of FIG. 1 for discharging a capacitor along with surge protection as taught by the present invention.

FIG. 3 is another embodiment of the present invention where surge protection is provided to a capacitor used to remove high-frequency components from an alternating current power signal.

### DETAILED DESCRIPTION

A surge protection circuit for use with a capacitor used to remove high-frequency components from an alternating current (AC) power signal is described. While in some instances specific details are provided such as specific components (e.g., TRIACs and varistors), it will be apparent to one skilled in the art that the invention can be practiced without these specific details. Moreover, some details that are apparent to one skilled in the art are not set forth, in order not to unnecessarily obscure the present invention.

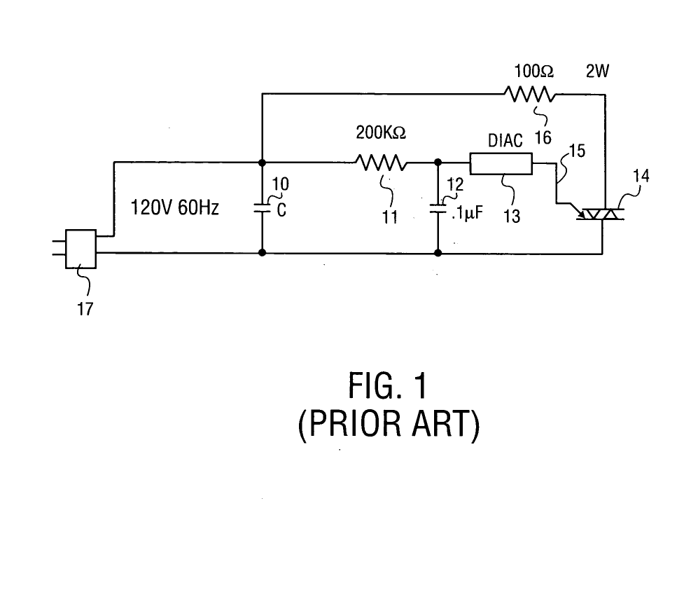

### Prior Art of FIG. 1

FIG. 1 shows a capacitor 10 used to remove high-frequency components from an AC power signal coupled to a plug 17. When the plug is removed from a mating receptacle, but for the circuitry shown to the right of the capacitor 10, a high voltage may appear on the prongs of the plug 17, potentially causing injury or at least discomfort if touched. The resistors 11 and 16, capacitor 12, and DIAC 13, together provide for the discharging of the capacitor 10 when it is unplugged, if the voltage on the capacitor at the instant of unplugging exceeds a predetermined voltage. This circuit is described in detail in U.S. Pat. No. 6,424,125.

One problem with the circuit of FIG. 1 is that the capacitor 10 has a rated voltage which should not be exceeded. If a surge occurs at the power source (e.g., the receptacle) the capacitor can be exposed to a voltage substantially more than the maximum voltage of the 120 volt (rms) power signal. For instance, if the capacitor 10 is rated for 400 volts, a surge in excess of 400 volts may occur that damages the capacitor 10. It is generally too costly to provide a capacitor that can handle very high voltages, for example, in excess of 600 volts for the capacitor shown in FIG. 1.

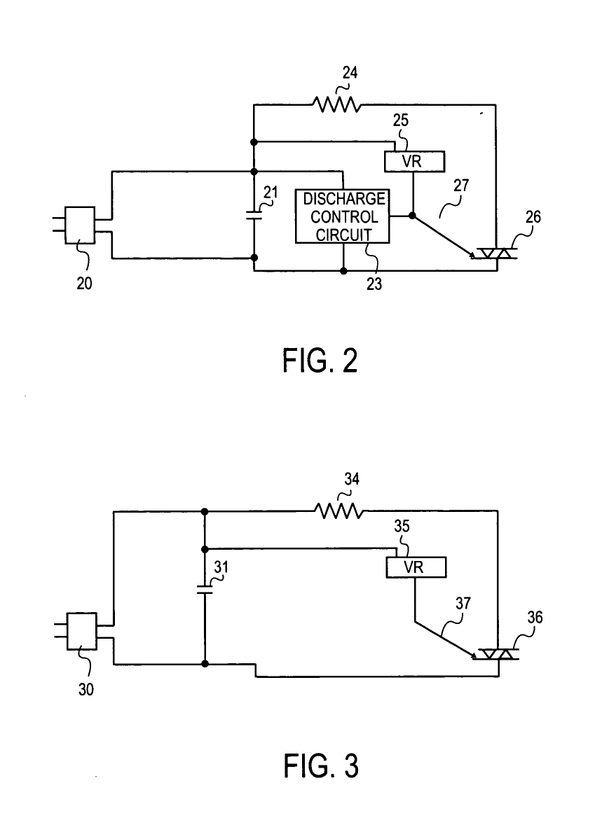

### Embodiment of FIG. 2

In FIG. 2, surge protection is provided in conjunction with a circuit for discharging the voltage across the capacitor. A plug 20 is shown for connecting to an ordinary power source such as a 120 volt AC outlet. A capacitor 21, which is a relatively large capacitor, is used to attenuate high-frequency components in the AC signal as discussed earlier. The circuit 23 senses when the power has been removed from the capacitor 21 and triggers the TRIAC 26 through its control electrode or gate 27 to discharge the capacitor 21. As can be seen in FIG. 2, the two main terminals of the TRIAC 26 provide a current path which includes the resistor 24, allowing the power stored in the capacitor 21, once it is disconnected, to be dissipated primarily in the resistor 24. The discharge control circuit 23 may be the circuit shown in FIG. 1 or other circuits for performing the same function. Note that when the plug 20 is unplugged the voltage across the capacitor 21 will not exceed the peak voltage of the power signal.

A variable resistor (VR) 25 is coupled between the gate 27 of the TRIAC 26 and the anode terminal of the TRIAC 26. The VR 25 may be a varistor as used in the prior art or some other non-linear resistance device. The resistance of the VR 25 drops from a high resistance to a low resistance once the voltage across the VR 25 reaches a predetermined voltage. While a varistor, particularly one having cross-bar characteristics, is currently preferred, other devices can perform the same function. For instance, back-to-back Zener diodes may be used. Where the voltage at the plug 20 is a 120 volts (rms), the VR 25 is selected so that its resistance changes at, for instance, 330 volts.

When the circuit of FIG. 2 is operating under normal conditions, the discharge control circuit does not trigger the TRIAC 26. Rather, the capacitor 21 being connected to the AC power source provides a low impedance path for the high-frequency components. There is no current through the resistor 24 since the TRIAC 26 is not conducting. During this operation, the gate 27 of the TRIAC 26 remains substantially at the potential of the cathode terminal of the TRIAC 26. The potential across the VR 25, under normal operation, does not exceed the peak voltage of 120 volt rms signal. Consequently, the VR 25 has a high impedance.

When a surge occurs, assuming for instance, it exceeds 330 volts, the resistance of the VR 25 drops and the gate 27 is pulled towards the anode terminal potential. This causes the TRIAC 26 to trigger into conduction. This conduction provides a low impedance path across the capacitor 21. The surge is essentially dissipated through the resistor 24 and TRIAC 26. The capacitor 21 is consequently not exposed to the high voltage of the surge.

Unlike prior art surge protection devices using varistors, the power of the surge is not dissipated in the varistor. Rather, the current associated with the surge is substantially confined to the resistor 24 and TRIAC 26. Thus, a smaller, less expensive varistor may be used. Also, the circuit breaker and associated light is not generally necessary.

### Embodiment of FIG. 3

In the embodiment of FIG. 3, the surge protection circuit operates substantially the same as the circuit shown in FIG. 2. It again provides surge protection to the capacitor 31. The difference between FIGS. 2 and 3 is that with FIG. 3 there is no discharging of the capacitor 31 when the plug 30 is decoupled from the power source. As shown in FIG. 3, a plug 30 engages an ordinary AC power source. The capacitor 31 attenuates high-frequency components in the AC power signal. A resistor 34 and a TRIAC 36 are coupled in series and across the capacitor 31. A variable resistor (VR) 35 is connected between the anode terminal and the gate 37 of the TRIAC 36.

When a surge occurs, the potential across the VR 35 rises to the predetermined (unusually high voltage), causing the TRIAC 36 to conduct. The power associated with the surge is dissipated in the resistor 34 and TRIAC 36. This prevents a high voltage from appearing across the capacitor 31. Once again the VR 35 is preferably a varistor having cross-bar characteristics.

While in FIGS. 2 and 3 a TRIAC is used, other three terminal control devices may be used which have two main terminals and a control terminal.

As mentioned earlier, one feature of the above-described surge protection circuit is that the varistor is not used to dissipate the power associated with the surge. This eliminates the need for a circuit breaker to protect the varistor. A light for indicating whether the circuit breaker is closed or open is also not necessary.

Thus, a surge protection circuit for protecting a capacitor used to attenuate high-frequency components in an AC power signal has been disclosed.

1. An apparatus for attenuating undesirable high frequency signals in an alternating current (AC) power signal comprising:
a capacitor;
a control device having two terminals and a control electrode, coupled to the capacitor;
a control circuit for sensing a high potential on the capacitor when it is disconnected from the AC power signal, coupled to the control electrode of the control device; and
a varistor coupled between one of the two terminals and the control electrode of the control device for surge protection from unusually high voltages at the power source, the variable resistor causing the control device to conduct in the presence of the unusually high voltage.

2. (Cancelled)

3. The apparatus of claim 1, wherein the varistor has cross-bar characteristics.

4. The apparatus of claims 1 or 3, wherein the control device is a TRIAC.

5. The apparatus of claim 4, wherein the two terminals of the control device are an anode terminal and cathode terminal, and wherein the varistor is coupled between the control electrode and the anode.

6. The apparatus of claim 1 including a resistor coupled in series with the control device

7-12. (Cancelled)
